(19) United States
(12) Patent Application Publication
(10) Pub. No.: US 2011/0088504 A1
(43) Pub. Date: Apr. 21, 2011

(54) GRIP SHIFTER ASSEMBLY

(75) Inventor: Tong Peng Cheng, Taichung County (TW)

(73) Assignee: FALCON CYCLE TECH. CO., LTD., Taichung County (TW)

(21) Appl. No.: 12/579,418

(22) Filed: Oct. 15, 2009

(51) Int. Cl. F16C 1/10

(52) U.S. Cl. 74/502.2

(57) ABSTRACT

A grip shifter assembly includes a stationary member coaxially sleeving on a bicycle handlebar. The stationary member has a receiving portion formed thereon. A rotary member coaxially rotatably sleeves on the stationary member. The rotary member has an annular portion formed thereon for abutting against the receiving portion. A grip coaxially securingly sleeves on the rotary member. The grip includes a first section, a middle section, and a second section disposed thereon. A plurality of protrusions radially and axially disposed on the first and the middle sections for grasping firmly. The protrusions are arranged in an equal space. The protrusions configure the first and the middle sections into a step-like cylindrical shape. Accordingly, the grip and the rotary member are able to pivotally rotate relative to the stationary member by a user for changing a speed of a bicycle.

### BACKGROUND OF THE INVENTION

1. Field of the Invention

The present invention relates to a grip shifter assembly, and more particularly to a grip shifter assembly with an improved grip.

2. Description of Related Art

A conventional bicycle speed change operation assembly in accordance with the prior art comprises a first speed change operation member and a second speed change operation member. Each of the first and the second change operation members is supported around a grip end portion of the handlebar about an axis of the handlebar for rotation. A cable winding member is rotated in response to a rotating operation of the speed change operation members for winding or paying out a speed control cable. A retaining mechanism holds the cable winding member at a predetermined rotational position. Therefore, the first speed change operation member is connected to the cable winding member for integral rotation therewith in a cable pulling direction and a cable paying out direction. The second speed change operation member is connected to the cable winding member by a transmission mechanism for rotating the cable winding member in the cable pulling direction or the cable paying out direction in response to rotational reciprocation of the second speed change operation member from a predetermined commencing point.

However, the first and second speed change operation members do not have any structure for increasing a friction on an outer surface thereof When a rider's hand grasps the handlebar and rotates the first and the second speed change operation members for a change of the speed, the first and the second speed operation members are difficult to grasp firmly for rotation.

The present invention has arisen to mitigate and/or obviate the disadvantages of the conventional bicycle speed change operation assembly.

### SUMMARY OF THE INVENTION

The main objective of the present invention is to provide an improved grip shifter assembly.

To achieve the objective, the grip shifter assembly in accordance with the present invention includes a stationary member adapting to coaxially sleeve on a bicycle handlebar. The stationary member is tubular. The stationary member has a receiving portion formed on one end thereof The receiving portion has an annular groove laterally defined therein. The receiving portion has two stopping portions formed on an inner periphery of the annular groove. The receiving portion has a series of teeth formed on the inner periphery of the annular groove and located between the two stopping portions. The stationary portion has a connecting portion formed on an outer periphery of the receiving portion for adapting to connect to a cable.

A rotary member coaxially rotatably sleeves on the stationary member. The rotary member is tubular. The rotary member has a plurality of elongated ribs axially, parallelly, and spacedly formed on an outer periphery thereof The rotary member has a plurality of elongated grooves defined in the outer periphery thereof Each elongated groove is located between two adjacent elongated ribs. The rotary member has an annular portion formed on one end thereof for abutting against the receiving portion. The annular portion has a speed scale disposed thereon for adapting to indicating a speed of the bicycle. The rotary member has a positioning portion laterally extending from the annular portion and extending toward the stationary member. The positioning portion is received in the annular groove. The positioning portion has a hole defined therein. The rotary member further includes a spring movably received in the hole and a pusher movably partially received in the hole. The spring has two ends respectively abutting against a bottom of the hole and a first end of the pusher. A second end of the pusher opposite to the first end engages with the teeth.

The grip shifter assembly further includes a grip coaxially securingly sleeving on the rotary member. The grip is tubular. The grip has a plurality of elongated ribs formed on an inner periphery thereof and corresponding to the elongated grooves. When each elongated rib of the rotary member is inserted into each elongated groove, the grip securingly engages with the rotary member. The grip includes a first section disposed on a first end of the grip and a middle section disposed on the grip and adjacent to the first section. The middle section has an outer diameter relatively greater than an outer diameter of the first section. The middle section has a tapered section located beside the first section. The tapered section is gradually tapered toward the first section. The grip includes a second section disposed on a second end of the grip opposite to the first end and adjacent to the middle section. The second section has an outer diameter greater than the outer diameter of the middle section. The second section is gradually tapered toward the middle section. The second section laterally abuts against the annular portion of the rotary member.

Moreover, the grip includes a plurality of protrusions radially and axially disposed on an outer periphery of the first and the middle sections for grasping firmly. The protrusions are arranged in an equal space. Each of the protrusions is quadrangular. The protrusions configure the first and the middle sections into a step-like cylindrical shape.

Accordingly, the grip and the rotary member are able to pivotally rotate relative to the stationary member by a rider for changing a speed of a bicycle.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of a grip shifter assembly in accordance with the present invention;

FIG. 2 is a perspective view of a stationary member of the grip shifter assembly in accordance with the present invention;

FIG. 3 is an assembled perspective view of the grip shifter assembly in accordance with the present invention;

FIG. 4 is an assembled cross-sectional plane view of the grip shifter assembly in accordance with the present invention; and

FIGS. 5-6 are partial operational cross-sectional plane view of the grip shifter assembly in accordance with the present invention.

### DETAILED DESCRIPTION OF THE INVENTION

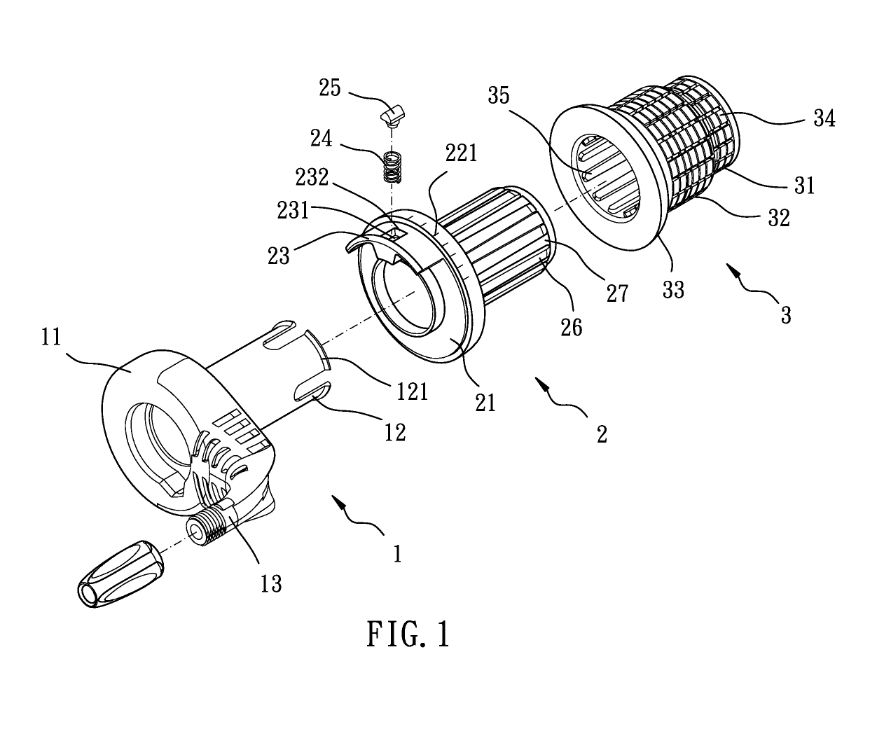

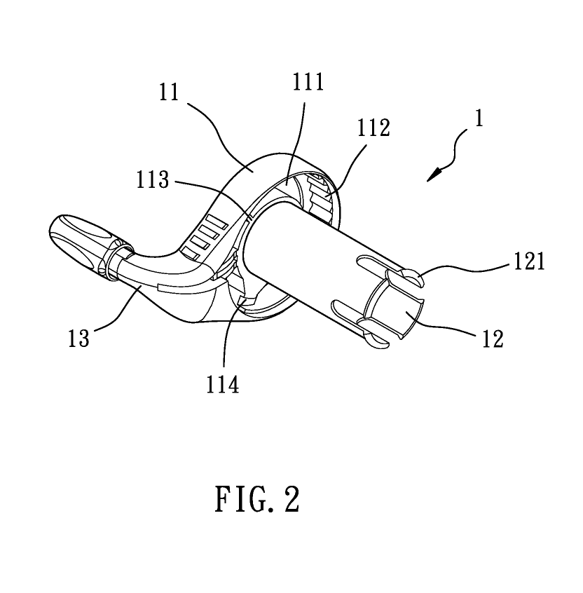

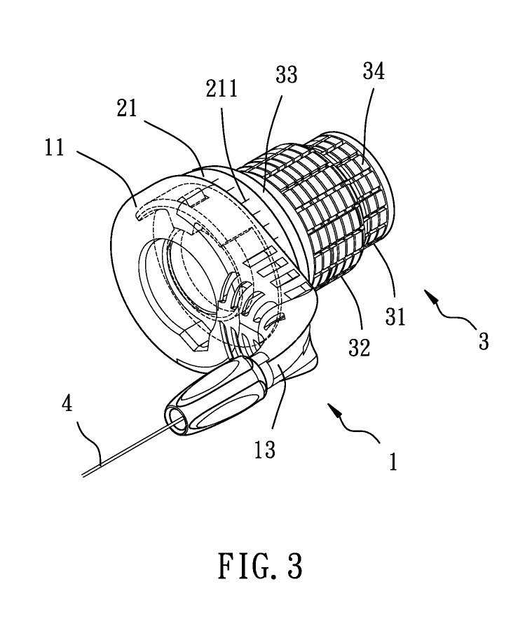

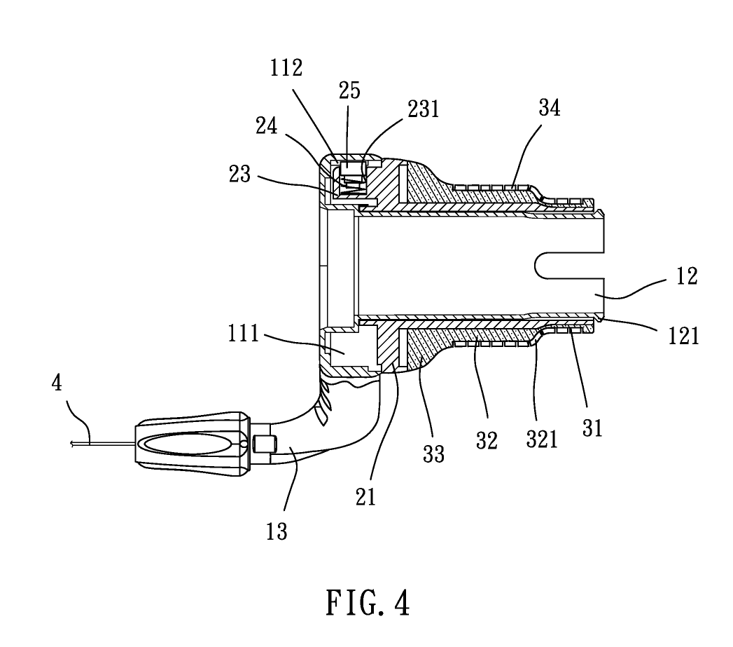

Referring to the drawings and initially to FIGS. 1-4, a grip shifter assembly in accordance with the present invention comprises a stationary member 1 being tubular. The stationary member 1 adapts to coaxially sleeve on a bicycle handlebar. The stationary member 1 has a receiving portion 11 formed on a first end thereof The receiving portion 11 has an annular groove 111 defined in a first lateral side thereof and surrounding the stationary member 1. The receiving portion 11 has two stopping portions 113, 114 formed on an inner periphery of the annular groove 111. The receiving portion 11 has a series of teeth 112 formed on the inner periphery of the annular groove 111 and located between the two stopping portions 113, 114.

The stationary member 1 has a plurality of movable portions 12 spacedly extending outwardly from a second end thereof opposite to the first end. Each of the movable portions 12 has a rib 121 formed on a distal end thereof The stationary portion 1 has a connecting portion 13 formed on an outer periphery of the receiving portion 11 for adapting to connect to a cable 4 of a bicycle derailleur device.

A rotary member 2 is tubular and coaxially rotatably sleeves on the stationary member 1. The rotary member 2 adapts to connect to the cable 4 via the connecting portion 13. The rotary member 2 has an annular portion 21 formed on one end thereof The annular portion 21 has a first lateral side abutting against the first lateral side of the receiving portion 11. The annular portion 21 has a speed scale 211 partially disposed on an outer periphery thereof for adapting to indicating a speed of the bicycle. The annular portion 21 has a positioning portion 23 extending from the first lateral side thereof and is movably received in the annular groove 111. The positioning portion 23 has a hole 231 defined therein. The hole 231 has an opening 232 facing towards the teeth 112. The rotary member 2 comprises a spring 24 movably received in the hole 231 and a pusher 25 movably partially received in the hole 231. The spring 24 has two ends respectively abutting against a bottom of the hole 231 and the pusher 25. The pusher 25 selectively engages with the teeth 112.

The rotary member 2 has a plurality of elongated ribs 26 axially, parallelly, and spacedly formed on an outer periphery thereof The rotary member 2 has a plurality of elongated grooves 27 defined in the outer periphery thereof Each elongated groove 27 is located between two adjacent elongated ribs 26.

The grip shifter assembly further comprises a grip 3 coaxially securingly sleeving on the rotary member 2. The grip 3 is tubular and configured into a step-like cylindrical shape. The grip 3 has a plurality of elongated ribs 35 formed on an inner periphery thereof and corresponding to the elongated grooves 27. When each elongated rib 35 of the grip 3 is inserted into each elongated groove 27 of the rotary member 2, the grip 3 securingly engages with the rotary member 2. The grip 3 has a first section 31 disposed on a first end of the grip 3, and a middle section 32 disposed on the grip 3 and adjacent to the first section 31. The middle section 32 has an outer diameter relatively greater than an outer diameter of the first section 31. The middle section 32 has a tapered section 321 located beside the first section 31. The tapered section 321 is gradually tapered toward the first section 31. The grip 3 has a second section 33 disposed on a second end thereof opposite to the first end and adjacent to the middle section 32. The second section 33 has an outer diameter greater than the outer diameter of the middle section 32. The second section 33 is gradually tapered toward the middle section 32. The second section 32 has a first lateral side abutting against a second lateral side of the annular portion 21 opposite to the first lateral side.

The grip 3 comprises a plurality of protrusions 34 radially and axially disposed on an outer periphery of the first and the middle sections 31, 32 for grasping firmly. Any two adjacent protrusions 34 are arranged in an equal space. Each of the protrusions 34 is quadrangular. The protrusions 34 configure the first and the middle sections 31, 32 into a step-like cylindrical shape for easily recognizing and comfortably grasping.

Moreover, when the movable portions 12 slightly inwardly bend, the grip 3 and the rotary member 2 easily sleeve on the stationary member 1. When the movable portions 12 return to the original position, the ribs 121 of the movable portions 12 lock the grip 3 and the rotary member 2 in place.

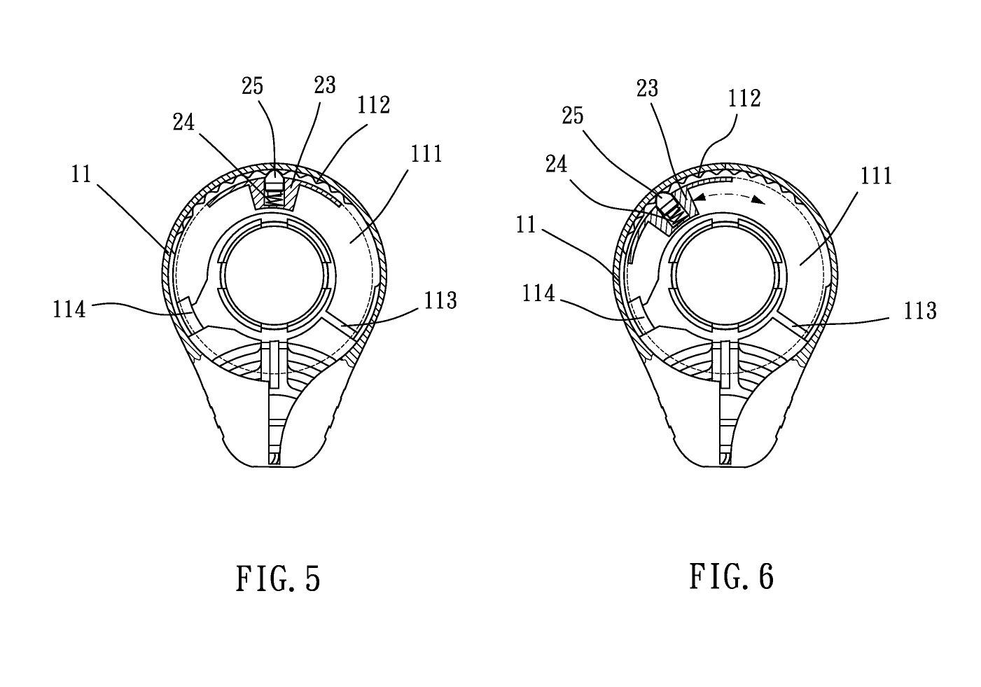

The operation of the grip shifter assembly in accordance with the present invention will be described in detailed below. As shown in FIGS. 5-6, when a rider grasps the grip 3 and rotates the grip 3 for changing the speed of the bicycle, the grip 3 and the rotary member 2 are both pivotally rotated relative to the stationary member 1. The positioning portion 23 slides along the annular groove 111, and the movement of the positioning portion 23 is limited by the two stopping portions 113, 114. When the pusher 25 moves to contact an edge of a tooth 112, the pusher 25 is retracted to compress the spring 24. As the pusher 25 engages with the teeth 112 again, the movement of the pusher 25 makes a sound for indicating a change of the speed. Accordingly, the cable 4 is axially moved to shift the bicycle derailleur device by the rotation of the rotary member 2 and the grip 3.

Although the invention has been explained in relation to its preferred embodiment, it is to be understood that many other possible modifications and variations can be made without departing from the spirit and scope of the invention as hereinafter claimed.

What is claimed is:

1. A grip shifter assembly comprising:
a stationary member adapting to coaxially sleeve on a bicycle handlebar, the stationary member being tubular, the stationary member having a receiving portion formed on a first end thereof;
a rotary member coaxially rotatably sleeving on the stationary member, the rotary member being tubular, the rotary member having an annular portion formed on one end thereof for abutting against the receiving portion; and
a grip coaxially securingly sleeving on the rotary member, the grip being tubular, the grip comprising:
a first section disposed on a first end of the grip;
a middle section disposed on the grip and adjacent to the first section, the middle section having an outer diameter relatively greater than an outer diameter of the first section, the middle section having a tapered section located beside the first section, the tapered section gradually tapered toward the first section;
a second section disposed on a second end of the grip opposite to the first end and adjacent to the middle section, the second section having an outer diameter greater than the outer diameter of the middle section, the second section gradually tapered toward the middle section, the second section laterally abutting against the annular portion of the rotary member; and
a plurality of protrusions radially and axially disposed on an outer periphery of the first and the middle sections for grasping firmly, the protrusions arranged in an equal space, wherein the protrusions configure the first and the middle sections into a step-like cylindrical shape;
wherein the grip and the rotary member are able to pivotally rotate relative to the stationary member by a user for changing a speed of a bicycle.

2. The grip shifter assembly as claimed in claim 1, wherein the rotary member has a plurality of elongated grooves axially, parallelly, and spacedly defined in an outer periphery thereof, the grip having a plurality of elongated ribs formed on an inner periphery thereof and corresponding to the elongated grooves,
wherein when each elongated rib is inserted into each elongated groove, the grip securingly engages with the rotary member.

3. The grip shifter assembly as claimed in claim 1, wherein each of the protrusions is quadrangular.

4. The grip shifter assembly as claimed in claim 1, wherein the rotary member has a positioning portion laterally extending from the annular portion and extending toward the stationary member, the positioning portion having a hole defined therein, the rotary member comprising a spring movably received in the hole and a pusher movably partially received in the hole, the spring having two ends respectively abutting against a bottom of the hole and the pusher, the annular portion having a speed scale disposed thereon for adapting to indicating a speed of the bicycle.

5. The grip shifter assembly as claimed in claim 4, wherein the stationary portion has a connecting portion formed on an outer periphery of the receiving portion for adapting to connect to a cable, the receiving portion having an annular groove defined therein for receiving the positioning portion, the receiving portion having two stopping portions formed on an inner periphery of the annular groove, the receiving portion having a series of teeth formed on the inner periphery of the annular groove and located between the two stopping portions for engaging with the pusher.
